(19) United States
(12) Patent Application Publication
(10) Pub. No.: US 2013/0163260 A1
(43) Pub. Date: Jun. 27, 2013

(54) LIGHT COLLECTING DEVICE

(71) Applicant: Industrial Technology Research Institute, Hsinchu (TW)

(72) Inventors: Hui-Hsiung Lin, Miaoli County (TW); Shu-Chun Chu, Tainan (TW); Hung-Yu Wu, Tainan (TW); Luan-Ying Chen, Changhua County (TW); Chun-Ting Lin, New Taipei (TW)

(73) Assignee: INDUSTRIAL TECHNOLOGY RESEARCH INSTITUTE, Hsinchu (TW)

(21) Appl. No.: 13/705,553

(22) Filed: Dec. 5, 2012

Related U.S. Application Data
(60) Provisional application No. 61/567,100, filed on Dec. 5, 2011.

(30) Foreign Application Priority Data
Oct. 26, 2012 (TW) 101139814

(51) Int. Cl. F21V 7/00

(52) U.S. Cl. CPC F21V 7/00
USPC 362/346

(57) ABSTRACT

A light collecting device includes at least one light guide plate having a body and at least one light guiding groove. The body has a bottom surface, a light entrance surface, a light exit surface and two opposite lateral surfaces between the bottom surface and the light entrance surface. A first acute angle is formed between the two lateral surfaces. Having a reflective surface and two opposite groove wall surfaces, the light guiding groove is formed and dented inward from the bottom surface. A second acute angle is formed between the two groove wall surfaces. The reflective surface is located at an end, close to the light exit surface, of the light guiding groove. An absolute value of a difference between the first acute angle and the second acute angle is less than or equal to 30 degrees.

### CROSS-REFERENCE TO RELATED APPLICATIONS

This non-provisional application claims priority under 35 U.S.C. §119(e) on Patent Application No(s). 61/567,100 filed in the United States on Dec. 5, 2011 and under 35 U.S.C. §119(a) on Patent Application No(s). 101139814 filed in Taiwan, R.O.C. on Oct. 26, 2012, the entire contents of which are hereby incorporated by reference.

### BACKGROUND

1. Technical Field

The disclosure relates to a light collecting device, and more particularly to a light collecting device with a light guide plate.

2. Related Art

With the progress of human life, our demand on energy resources has been continuously increased. However, as the energy resources on the earth are drying up, the shadow of energy crisis lingers. Therefore, experts from all fields are devoted to research and development of various alternative energy resources. Development of solar power generation is the most dynamic activity among development of all alternative energy resources.

During the solar power generation, a solar cell made of a semiconductor material absorbs light or photons to excite electrons in the semiconductor, thereby generating a driving voltage. Silicon is the most common material among all solar cell materials. However, the generating efficiency of the solar cell made of silicon cannot be improved due to a limited spectral absorption capability of the silicon, a flat silicon surface that partially reflects sunlight and causes a loss of optical energy, and other factors.

Therefore, persons skilled in the art utilize a light collector to improve the generating efficiency of the solar cell. Take a light collector with a planar light guide plate as an example. It comprises a light entrance surface and a light exit surface. The solar cell is disposed on the light exit surface, and the light entrance surface receives sunlight. Through a high light collection ratio (i.e., area of the light entrance surface divided by area of the light exit surface) of the light collector with a planar light guide plate, the power generating efficiency of the solar cell is improved. However, in the design of the light collector with a planar light guide plate that has a high light collection ratio, energy loss is more likely to occur when sunlight is transmitted inside the light collector, which reduces light collection efficiency of the light collector.

In view of this, how to integrate high light collection ratio and high light collection efficiency on a light collector with a planar light guide plate is a problem to be solved by researchers.

### SUMMARY

The disclosure provides a light collecting device comprising at least one light guide plate. The light guide plate comprises a body and at least one light guiding groove. The body has a bottom surface and a light entrance surface that are opposite to each other, as well as a light exit surface and two opposite lateral surfaces between the bottom surface and the light entrance surface. A first acute angle is formed between the two lateral surfaces of the body. A distance between the two lateral surfaces of the body decreases along a direction away from the light exit surface. The light guiding groove is formed and dented from the bottom surface into the body. The light guiding groove has a reflective surface and two opposite groove wall surfaces, wherein a second acute angle is formed between the two groove wall surfaces. A distance between the two groove wall surfaces decreases along a direction away from the light exit surface. The reflective surface is located at an end, close to the light exit surface, of the light guiding groove, wherein a third acute angle is formed between the reflective surface and the light entrance surface. Furthermore, an absolute value of a difference between the first acute angle and the second acute angle is less than or equal to 30°.

### BRIEF DESCRIPTION OF THE DRAWINGS

The present disclosure will become more fully understood from the detailed description given herein below for illustration only, and thus are not limitative of the present disclosure, and wherein:

FIG. 1 and FIG. 2 are perspective schematic structural views of a light collecting device according to one embodiment of the disclosure;

FIG. 3 is a structural front view of a light collecting device according to one embodiment of the disclosure;

FIG. 4 is a structural side view of a light collecting device according to one embodiment of the disclosure;

FIG. 5 is a structural front view of a light collecting device according to another embodiment of the disclosure;

FIG. 6 is a structural front view of a light collecting device according to another embodiment of the disclosure;

FIG. 7 is a structural front view of a light collecting device according to another embodiment of the disclosure;

FIG. 8 is a structural front view of a light collecting device according to another embodiment of the disclosure;

FIG. 9 is a structural front view of a light collecting device according to another embodiment of the disclosure;

FIG. 10A is a structural side view of a light collecting device according to another embodiment of the disclosure being applied to a solar cell;

FIG. 10B is a view of a conduction path of a light inside a light collecting device according to FIG. 10A;

FIG. 10C is a partial enlarged view of FIG. 10B; and

FIG. 11A to FIG. 13 are line charts of simulation data of a light collecting device according to one embodiment of the disclosure.

### DETAILED DESCRIPTION

The detailed features and advantages of the disclosure are described below in great detail through the following embodiments, the content of the detailed description is sufficient for those skilled in the art to understand the technical content of the present disclosure and to implement the disclosure there accordingly. Based upon the content of the specification, the claims, and the drawings, those skilled in the art can easily understand the relevant objectives and advantages of the disclosure.

The disclosure provides a light collecting device for integrating a high light collection ratio and high light collection efficiency on a light collector with a planar light guide plate.

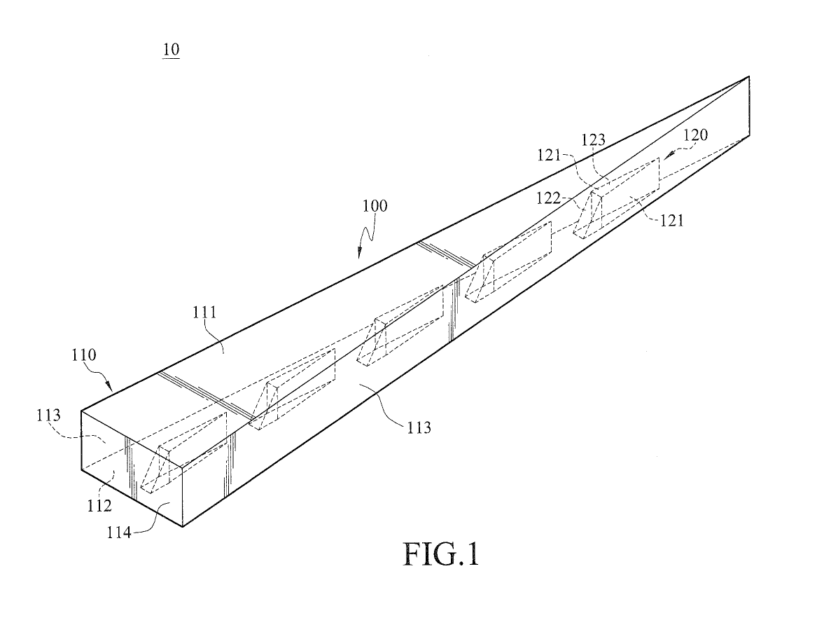

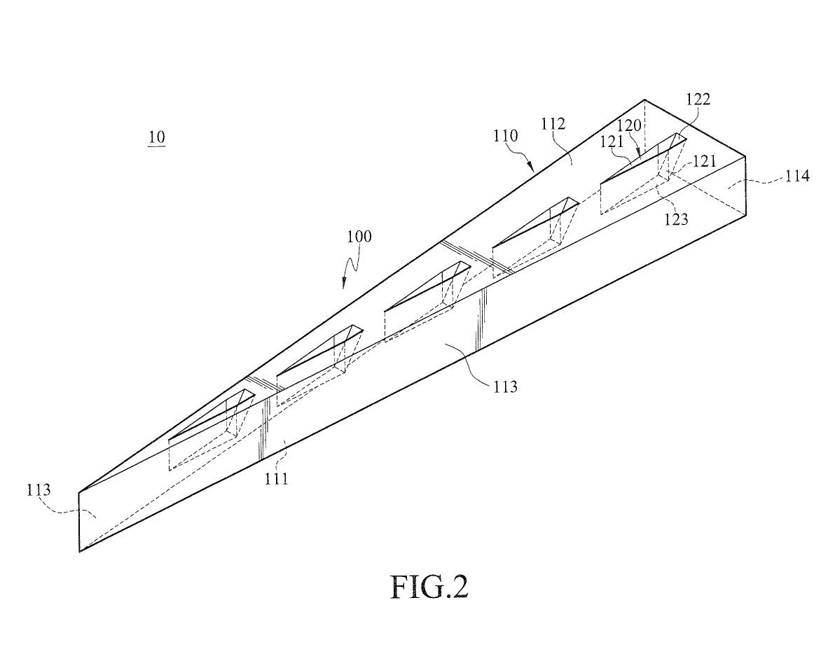

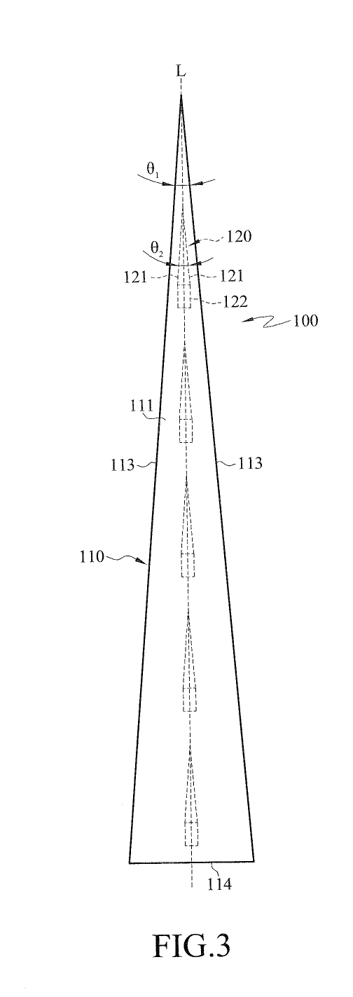

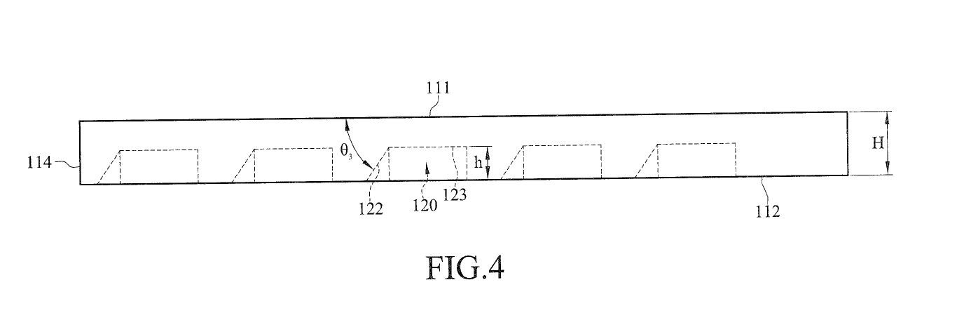

Referring to FIGS. 1 to 4, FIGS. 1 and 2 are perspective schematic structural views of a light collecting device according to one embodiment of the disclosure. FIG. 3 is a structural front view of a light collecting device according to one embodiment of the disclosure. FIG. 4 is a structural side view of a light collecting device according to one embodiment of the disclosure. The dimension scale of the drawings of this embodiment is merely provided for the convenience of reading, and is not limitative of the disclosure.

A light collecting device 10 according to one embodiment of the disclosure is applicable to solar power generation, for improving the efficiency of solar power generation. However, the application field of the light collecting device 10 is not limitative of the disclosure.

The light collecting device 10 comprises at least one light guide plate 100. This embodiment uses one light guide plate 100 as an example but the disclosure is not limited thereto. The light guide plate 100 comprises a body 110 and at least one light guiding groove 120. As shown in the drawings, this embodiment uses the five light guiding grooves 120 as an example but the disclosure is not limited thereto.

The body 110 has a bottom surface 112 and a light entrance surface 111 that are opposite to each other. The body 110 further has a light exit surface 114 and two opposite lateral surfaces 113. Both the two opposite lateral surfaces 113 are located between the bottom surface 112 and the light entrance surface 111. The bottom surface 112 is substantially parallel to the light entrance surface 111. The light exit surface 114 and the two opposite lateral surfaces 113 are substantially perpendicular to the bottom surface 112 or the light entrance surface 111. A first acute angle 01 is formed between the two lateral surfaces 113, and a distance between the two lateral surfaces 113 decreases along a direction away from the light exit surface 114. Furthermore, two opposite ends of the light exit surface 114 are respectively connected to the two lateral surfaces 113. The distance between the two lateral surfaces 113 decreases along the direction away from the light exit surface 114. The two lateral surfaces 113 are finally connected to an end edge of the body 110. Therefore, the front view of the shape of the light guide plate 100 according to this embodiment is a triangle, for example, an isosceles triangle (that is, the two lateral surfaces 113 may have the same length).

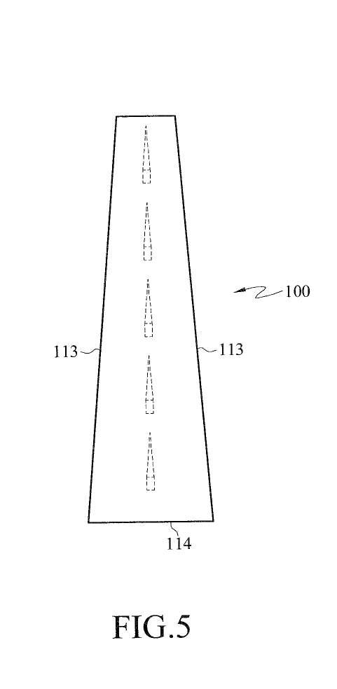

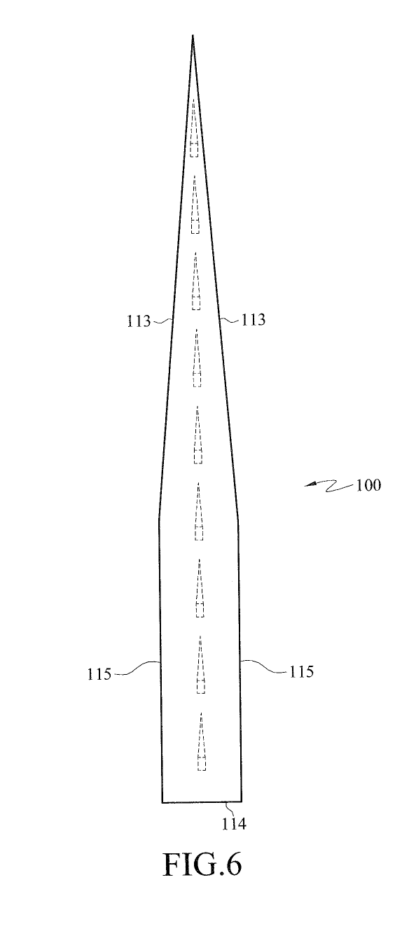

In this embodiment or other embodiments, the shape of the light guide plate 100 is not limitative of the disclosure. For example, in the embodiment shown in FIG. 5, the two opposite ends of the light exit surface 114 are respectively connected to the two lateral surfaces 113, and a distance is kept between unconnected ends, away from the light exit surface 114, of the two lateral surfaces 113. Therefore, the front view of the shape of the light guide plate 100 is a trapezoid, for example, an isosceles trapezoid. Alternatively, in the embodiment shown in FIG. 6, the two opposite ends of the light exit surface 114 keep a distance from the two lateral surfaces 113 respectively, and the two lateral surfaces 113 are connected to the two opposite ends of the light exit surface 114 respectively through a connection surface 115. The two connection surfaces 115 are parallel to each other, and ends of the two lateral surfaces 113 which are away from the light exit surface 114 are connected with each other. Therefore, the front view of the shape of the light guide plate 100 is a pentagon.

In addition, each light guiding groove 120 in the embodiment is formed and dented from the bottom surface 112 of the body 110 into the body 110. Each light guiding groove 120 has a reflective surface 122 and two opposite groove wall surfaces 121. Moreover, each light guiding groove 120 has a groove bottom surface 123, and the groove bottom surface 123 is substantially parallel to the bottom surface 112 of the body 110. The reflective surface 122 and the two opposite groove wall surfaces 121 are all connected to an end edge of the groove bottom surface 123, so that the groove bottom surface 123 is surrounded by the reflective surface 122 and the two opposite groove wall surfaces 121. In this embodiment, the two groove wall surfaces 121 are connected and a second acute angle θ2 is formed between the two groove wall surfaces 121. A distance between the two groove wall surfaces 121 decreases along a direction away from the light exit surface 114. The reflective surface 122 is located at an end of the light guiding groove 120 which is close to the light exit surface 114. A third acute angle θ3 is formed between the reflective surface 122 and the light entrance surface 111. The reflective surface 122 is used to reflect a light, which enters the light guide plate 100 from the light entrance surface 111, to the light exit surface 114. Furthermore, an absolute value of a difference between the first acute angle θ1 and the second acute angle θ2 is less than or equal to 30 degrees (°) (that is, −30°≦first acute angle θ1−second acute angle θ2≦30°.

In this embodiment or some embodiments, the first acute angle θ1 may range from 2° to 30°, and the second acute angle θ2 may range from 2° to 30°. Persons skilled in the art are capable of adjusting the first acute angle θ1 and the second acute angle θ2 according to actual requirements.

In this embodiment or some embodiments, an angular bisector L of the first acute angle θ1 may overlap an angular bisector L of the second acute angle θ2. Moreover, the first acute angle θ1 may be equal to the second acute angle θ2, so that the two groove wall surfaces 121 may be respectively parallel to the two lateral surfaces 113.

Moreover, in this embodiment or some embodiments, the third acute angle θ3 may range from 44° to 64°. In one embodiment, the third acute angle θ3 may be 45°.

Furthermore, in this embodiment or some embodiments, the body 110 has a thickness H, and the thickness H is a distance from the bottom surface 112 to the light entrance surface 111. The light guiding groove 120 is formed and dented from the bottom surface 112 into the body 110, which contributes to a depth h. The depth h is a distance from the bottom surface 112 to the groove bottom surface 123. A ratio d between the depth h and the thickness H satisfies the following relation: 0.1≦d=(depth h divided by thickness H)≦1. When the ratio d (depth h divided by thickness H) is equal to 1, it indicates that the light guiding groove 120 penetrates the bottom surface 112 and reaches the light entrance surface 111.

In addition, in this embodiment or some embodiments, an area of the light entrance surface 111 and an area of the light exit surface 114 satisfy the following relation: (area of the light entrance surface 111 divided by area of the light exit surface 114)≧300. In other words, the light collecting device 10 in this embodiment has a high light collection ratio.

In this embodiment, the first acute angle 01 is formed between the two lateral surfaces 113 of the body 110 of the light guide plate 100, the second acute angle θ2 is formed between the two groove wall surfaces 121 of the light guiding groove 120, and the absolute value of the difference between the first acute angle θ1 and the second acute angle θ2 is less than or equal to 30°. Therefore, the light that enters the light guide plate 100 from the light entrance surface 111 is capable of being emitted by the light exit surface 114 after total reflection in the light guide plate 100. Hence the light guide plate 100 in this embodiment achieves not only the high light collection ratio, but also a high light collection efficiency (light collection efficiency equals total power of the light that enters the light entrance surface divided by total power of the light that is emitted from the light exit surface).

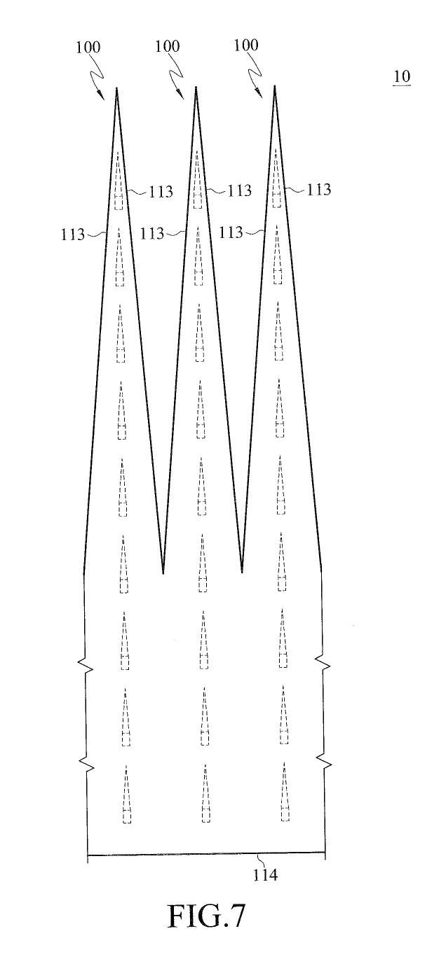

Referring to FIG. 7, which is a structural front view of a light collecting device according to another embodiment of the disclosure. A light collecting device 10 of this embodiment is similar to that of the embodiment shown in FIG. 1 to FIG. 4, and the same reference numerals represent similar components.

The light collecting device 10 in this embodiment comprises a plurality of light guide plates 100 disposed side by side. The light exit surfaces 114 of the light guide plates 100 face the same direction. Lateral surfaces 113 of two adjacent light guide plates 100 are opposite to each other, and an acute angle is formed between the lateral surfaces 113. In this embodiment, light guide plates 100 the same as that in the embodiment shown in FIG. 6 are used for side-by-side arrangement. Ends of the light guide plates 100 which have light exit surfaces 114 are connected with each other, and the light exit surfaces 114 of the light guide plates 100 are coplanar.

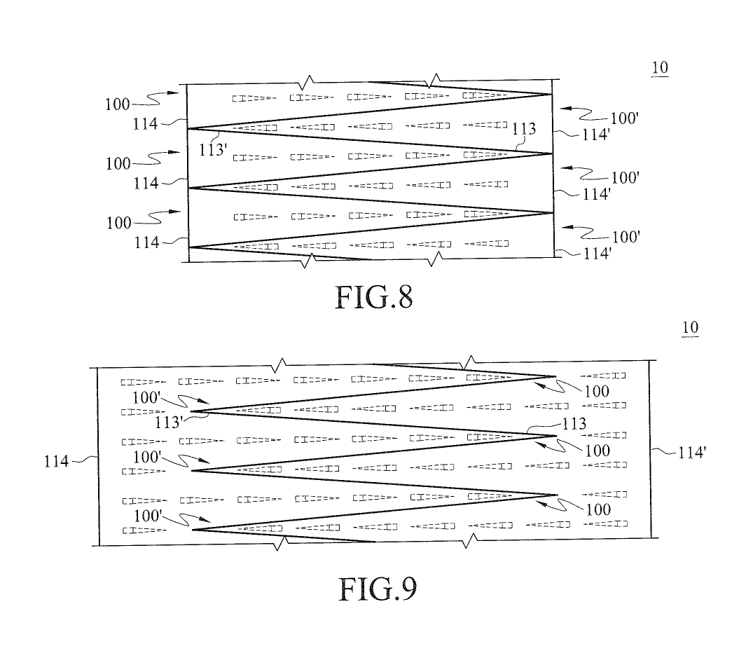

Referring to FIG. 8, which is a structural front view of a light collecting device according to another embodiment of the disclosure. A light collecting device 10 of this embodiment is similar to that of the embodiment shown in FIG. 1 to FIG. 4, and the same reference numerals represent similar components.

The light collecting device 10 in this embodiment comprises a plurality of light guide plates 100 and 100′ disposed side by side. In this embodiment, light guide plates 100 the same as that in the embodiment shown in FIG. 1 to FIG. 4 are used for side-by-side arrangement. Two light exit surfaces 114 and 114′ of two adjacent light guide plates 100 and 110′ face opposite directions, and lateral surfaces 113 and 113′ of the two adjacent light guide plates 100 and 100′ are adhered.

Referring to FIG. 9, which is a structural front view of a light collecting device according to another embodiment of the disclosure. A light collecting device 10 of this embodiment is similar to that of the embodiment shown in FIG. 1 to FIG. 4, and the same reference numerals represent similar components.

The light collecting device 10 in this embodiment comprises a plurality of light guide plates 100 and 100′ disposed side by side. Two light exit surfaces 114 and 114′ of two adjacent light guide plates 100 and 110′ face opposite directions, and lateral surfaces 113 and 113′ of the two adjacent light guide plates 100 and 100′ are adhered to each other. In addition, ends of two spaced light guide plates 100 which have light exit surfaces 114 are connected with each other(as shown in the left part of FIG. 9), and the light exit surfaces 114 of the two spaced light guide plates 100 are coplanar. In addition, ends of two spaced light guide plates 100′ which have light exit surfaces 114′ are connected with each other(as shown in the right part of FIG. 9), and the light exit surfaces 114′ of the two spaced light guide plates 100′ are coplanar. Compared with FIG. 8, in this embodiment, light guide plates 100 the same as that in the embodiment shown in FIG. 6 are used for side-by-side arrangement.

More specifically, in the light collecting devices 10 shown in FIGS. 8 and 9, the two light exit surfaces 114 and 114′ of the two adjacent light guide plates 100 and 100′ face opposite directions, so that the light collecting device 10 has the light exit surfaces 114 and 114′ in two directions. Therefore, the light collecting device 10 is capable of being used more flexibly.

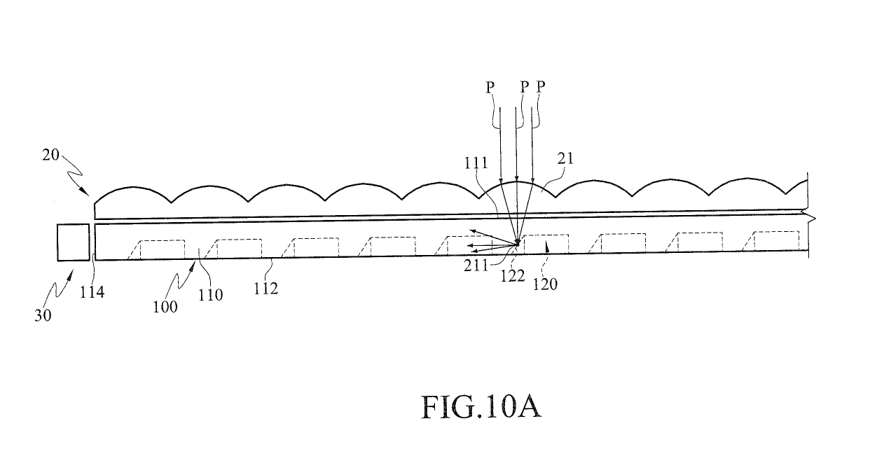

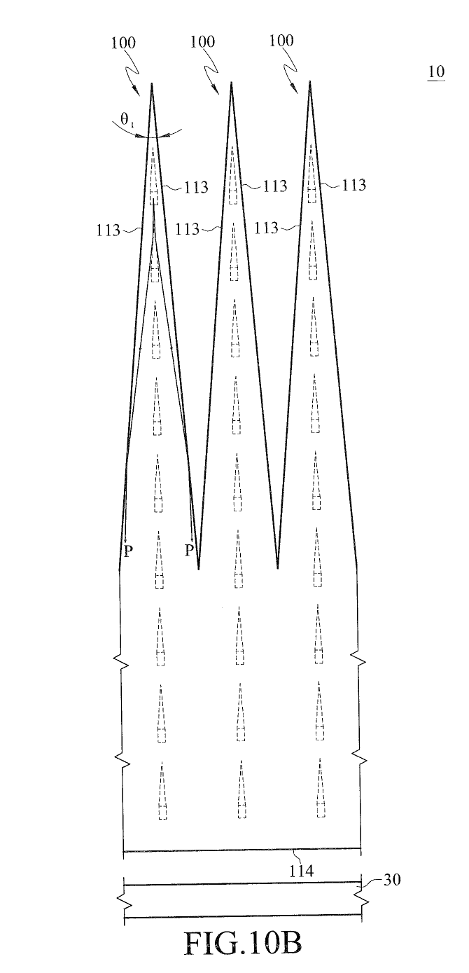

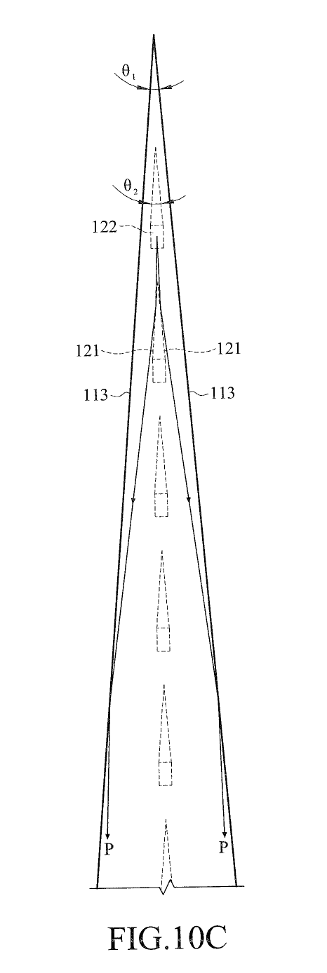

Referring to FIGS. 10A to 10C, FIG. 10A is a structural lateral surface view of a light collecting device according to another embodiment of the disclosure being applied to a solar cell. FIG. 10B is a view of a conduction path of a light inside a light collecting device according to FIG. 10A. FIG. 10C is a partial enlarged view of FIG. 10B. A light collecting device 10 of this embodiment is similar to that of the embodiment shown in FIG. 7, and the same reference numerals represent similar components.

In this embodiment, the light collecting device 10 further comprises a lens board 20. The lens board 20 is disposed on the light entrance surface 111 of the body 110 of the light guide plate 100. A solar cell 30 is disposed on the light exit surface 114 of the body 110. The lens board 20 comprises at least one lens 21. The drawings of this embodiment use a plurality of lenses 21 as an example. However, the number of lenses 21 is not intended to limit the disclosure. The light guide plate 100 has a plurality of light guiding grooves 120. The number of the light guiding grooves 120 matches the number of the lenses 21. A focal point 211 of the lens 21 is located on the reflective surface 122 of the light guiding groove 120.

In this embodiment, when a light P passes through the lens board 20, the lens 21 focuses the light P to the reflective surface 122. The light P is reflected, by the reflective surface 122, to the light exit surface 114. Thus, the lens board 20 further improves the light collection efficiency of the light collecting device 10.

Moreover, when the light P is incident on the reflective surface 122 of the light guiding groove 120 after being focused by the lens 21, the incident light P is deflected by the reflective surface 122 and is transmitted in the light guide plate 100, advancing toward the light exit surface 114. Due to the first acute angle θ1 between the two lateral surfaces 113 and the second acute angle θ2 between the two groove wall surfaces 121, the light P transmitted in the light guide plate 100 contacts the lateral surfaces 113 of the body 110 or the groove wall surfaces 121 of the light guiding groove 120. The transmission path of the light P is rectified through the lateral surfaces 113 or the groove wall surfaces 121, so that an incident angle of the light P on a surface of the body 110 does not exceed a critical angle, and the light P is transmitted to the light exit surface 114 through total reflection and then emitted from the light exit surface 114. It is prevented that the light P is emitted from surfaces other than the light exit surface 114 as the incident angle of the light P exceeds the critical angle during transmission in the light guide plate 100, thereby avoiding an energy loss of the light.

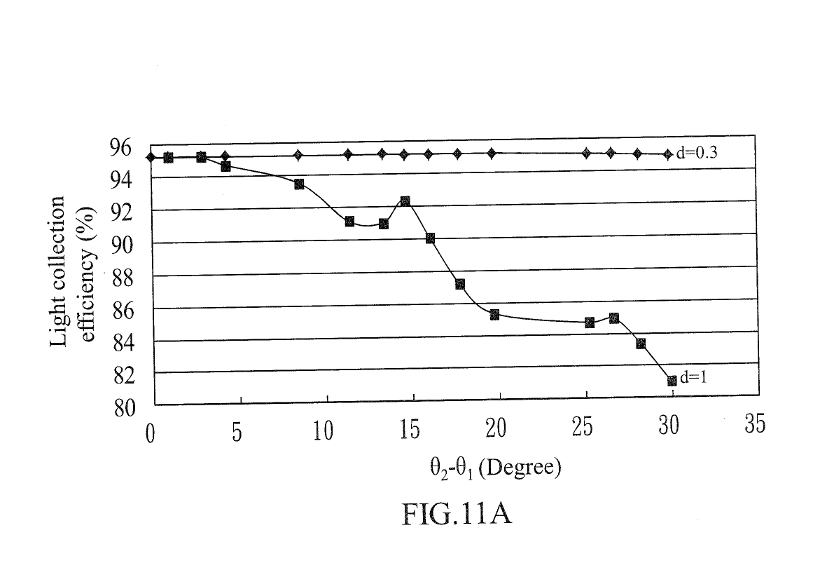

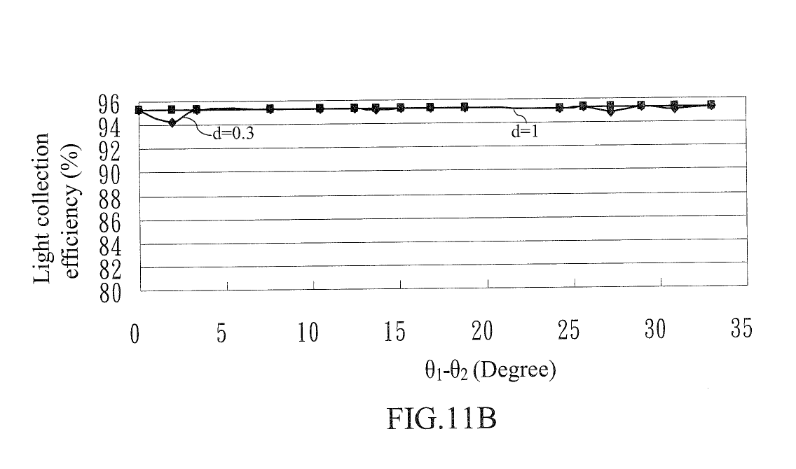

Referring to FIGS. 11A to 13, FIG. 11A to FIG. 13 are line charts of simulation data of the light collecting device according to the embodiment shown in FIG. 10A. The following simulation data is obtained by using optical simulation software Lightools® and a model of the embodiment shown in FIG. 1.

FIG. 11A shows values of the light collection efficiency simulated based on different values of the second acute angle θ2 minus the first acute angle θ1 under the following conditions: first acute angle θ1=2.86°, third acute angle θ3=45°, (depth h divided by thickness H)=ratio d=1 and 0.3, and light collection ratio (area of the light entrance surface 111 divided by area of the light exit surface 114)=300. According to the simulated line chart, when second acute angle θ2−first acute angle θ1≦30° (namely, −30°≦(first acute angle θ1−second acute angle θ2)), values of the light collection efficiency are greater than 80%.

FIG. 11B shows values of the light collection efficiency simulated based on different values of the second acute angle θ2 minus the first acute angle θ1 under the following conditions: second acute angle θ2=3.82°, third acute angle θ3=45°, (depth h divided by thickness H)=ratio d=1 and 0.3, and light collection ratio (area of the light entrance surface 111 divided by area of the light exit surface 114)=300. According to the simulated line chart, when (the first acute angle θ1−the second acute angle θ2)≦30°, values of the light collection efficiency are greater than 94%.

According to the data analysis in FIG. 11A and FIG. 11B, values of the light collection efficiency of the light collecting device according to the disclosure are greater than 80% under the following conditions: −30°≦(first acute angle θ1−second acute angle θ2)≦30° (that is, the absolute value of the difference between the first acute angle θ1 and the second acute angle θ2 is less than or equal to 30°), third acute angle θ3=45°, (depth h divided by thickness H)=1 or 0.3, and light collection ratio=300.

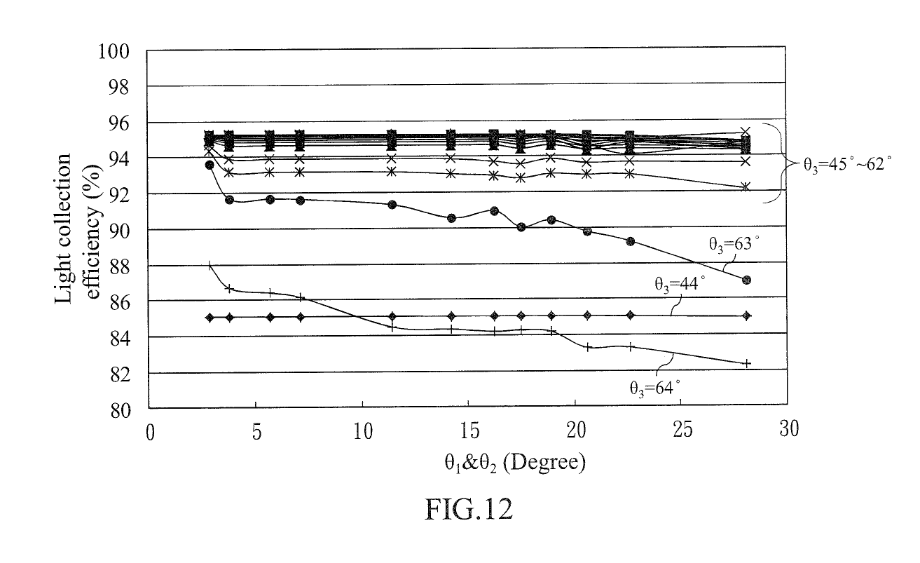

FIG. 12 shows values of the light collection efficiency simulated based on different values of the second acute angle θ2 and the acute angle θ1 under the following conditions: first acute angle θ1=second acute angle θ2, the third acute angle θ3 ranges from 44° to 64°, (depth h divided by thickness H)=ratio d=1, and light collection ratio (area of the light entrance surface 111 divided by area of the light exit surface 114)=300. The three lines from bottom to top respectively represent simulation results based on different values of the first acute angle θ1 and second acute angle θ2 when the third acute angle θ3 is respectively 64°, 44°, and 63°. Other lines represent simulation results based on different values of the first acute angle θ1 and second acute angle θ2 when the third acute angle θ3 ranges from 45° to 62°. According to the simulated line charts, values of the light collection efficiency of the light collecting device are greater than 80% when the third acute angle θ3 ranges from 44° to 64°, and 2.5°<first acute angle θ1=second acute angle θ2<28°.

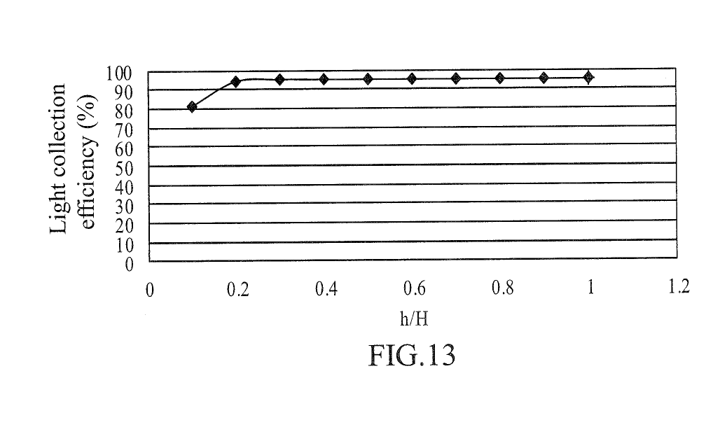

FIG. 13 shows values of the light collection efficiency simulated based on different values of the ratio d (depth h divided by thickness H) under the following conditions: first acute angle θ1=second acute angle θ2=3.8°, third acute angle θ3=45° , and light collection ratio (area of the light entrance surface 111 divided by area of the light exit surface 114)=300. According to the simulated line chart, when 0.1≦(depth h divided by thickness H)=ratio d≦1, values of the light collection efficiency are greater than 80%.

In the light collecting device according to the above embodiments, the first acute angle is formed between the two lateral surfaces of the body of the light guide plate, the second acute angle is formed between the two groove wall surfaces of the light guiding groove, and the absolute value of the difference between the first acute angle θ1 and the second acute angle θ2 is less than or equal to 30°. When a light enters the light guide plate from the light entrance surface, it is emitted from the light exit surface after total reflection in the light guide plate, thereby improving the light collection efficiency of the light guide plate. Therefore, the light collecting device in the embodiment is capable of achieving both the high light collection ratio and high light collection efficiency.

The foregoing description of the exemplary embodiments of the disclosure has been presented for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the disclosure pertains without departing from its spirit and scope. Accordingly, the scope of the disclosure is defined by the appended claims rather than the foregoing description and the exemplary embodiments described therein.

What is claimed is:

1. A light collecting device, comprising at least one light guide plate, the light guide plate comprising:
a body having a bottom surface and a light entrance surface opposite to each other, as well as a light exit surface and two lateral surfaces opposite to each other, the light exit surface and the lateral surfaces being located between the bottom surface and the light entrance surface, a first acute angle being formed between the two lateral surfaces, and a distance between the two lateral surfaces decreasing along a direction away from the light exit surface; and
at least one light guiding groove, formed and dented from the bottom surface into the body, the light guiding groove having a reflective surface and two groove wall surfaces opposite to each other, a second acute angle being formed between the two groove wall surfaces, and a distance between the two groove wall surfaces decreasing along a direction away from the light exit surface, the reflective surface being located at an end of the light guiding groove wherein the end of the light guiding groove is close to the light exit surface, and a third acute angle being formed between the reflective surface and the light entrance surface, wherein an absolute value of a difference between the first acute angle and the second acute angle being less than or equal to 30°.

2. The light collecting device according to claim 1, wherein the first acute angle ranges from 2° to 30°.

3. The light collecting device according to claim 1, wherein the second acute angle ranges from 2° to 30°.

4. The light collecting device according to claim 1, wherein the third acute angle ranges from 44° to 64°.

5. The light collecting device according to claim 1, wherein an area of the light entrance surface divided by an area of the light exit surface is greater than or equal to 300.

6. The light collecting device according to claim 1, wherein an angular bisector of the first acute angle overlaps an angular bisector of the second acute angle.

7. The light collecting device according to claim 1, wherein the two groove wall surfaces are respectively parallel to the two lateral surfaces.

8. The light collecting device according to claim 1, wherein the body has a thickness, the thickness is a distance from the bottom surface to the light entrance surface, the light guiding groove is formed and dented from the bottom surface into the body, contributing to a depth, and the depth divided by the thickness is greater than or equal to 0.1 as well as less than or equal to 1.

9. The light collecting device according to claim 1, further comprising the multiple light guide plates located side by side, and the light exit surfaces of the light guide plates facing the same direction.

10. The light collecting device according to claim 9, wherein ends of the light guide plates having the light exit surfaces are connected with each other, and the light exit surfaces are coplanar.

11. The light collecting device according to claim 1, comprising the multiple light guide plates located side by side, and the two light exit surfaces of the two light guide plates adjacent to each other facing opposite directions.

12. The light collecting device according to claim 11, wherein ends of the two spaced light guide plates having the light exit surfaces are connected with each other, and the two light exit surfaces of the two spaced light guide plates are coplanar.

13. The light collecting device according to claim 1, further comprising a lens board disposed on the light entrance surface, the lens board comprising at least one lens, and a focal point of the lens being located on the reflective surface.

14. The light collecting device according to claim 13, wherein the light guide plate has multiple light guiding grooves, the lens board has multiple lenses, and the number of the light guiding grooves matches the number of the lenses.

15. The light collecting device according to claim 1, wherein two opposite ends of the light exit surface keep a distance from the two lateral surfaces, the two lateral surfaces are connected to the two opposite ends of the light exit surface respectively through a connection surface, the two connection surfaces being parallel to each other, and wherein ends of the two lateral surfaces, which are away from the light exit surface, are connected with each other.
